(19) United States
(12) Patent Application Publication
(10) Pub. No.: US 2020/0110978 A1
(43) Pub. Date: Apr. 9, 2020

(54) TIRE

(71) Applicant: Toyo Tire Corporation, Itami-shi (JP)

(72) Inventor: Harunobu SUITA, Itami-shi (JP)

(73) Assignee: Toyo Tire Corporation, Itami-shi (JP)

(21) Appl. No.: 16/587,393

(22) Filed: Sep. 30, 2019

(30) Foreign Application Priority Data
Oct. 3, 2018 (JP) 2018-188137

(51) Int. Cl. G06K 19/077; H01Q 1/22

(52) U.S. Cl. CPC G06K 19/07764; B29D 2030/0077; H01Q 1/2225

(57) ABSTRACT

A tire includes: a carcass ply extending from one bead core to another bead core; side-wall rubber arranged at an outer side in the tire-width direction of the carcass ply; a belt arranged at an outer side in the tire-radial direction of the carcass ply in the tread; and a pad arranged between the carcass ply and an end region in the tire-width direction of the belt, in which the pad extends up to an outer side in the tire-width direction, the pad and side-wall rubber is laminated at part of the carcass ply, and an electronic component is embedded between the pad and side-wall rubber.

### CROSS-REFERENCE TO RELATED APPLICATIONS

This application is based on and claims the benefit of priority from Japanese Patent Application No. 2018-188137, filed on 3 Oct. 2018, the content of which is incorporated herein by reference.

### FIELD

The present invention relates to a tire in which an electronic component is embedded.

### BACKGROUND

Conventionally, tires in which an electric component such as RFID is embedded within the rubber structure have been known. With such tires, by an RFID tag embedded in the tire and a reader as an external device carrying out communication, it is possible to perform production control of tires, usage history management, etc. For example, Japanese Unexamined Patent Application, Publication No. 2005-335384 discloses a tire arranging a patch combined with an electronic component having an antenna at a portion adjacent to an inner liner. In addition, it shows also being able to arrange the electronic component between the carcass and side wall, or between the carcass and a tread portion.

### SUMMARY

In the technology shown in Patent Document 1, in the case of arranging the electronic component between the carcass and side wall, for example, since the properties greatly differ between the carcass and side wall, the relative movement arises between both members during vulcanization and during use due to this difference in properties, for example, differences in linear expansion coefficient, elastic modulus, etc., and there is a possibility of the electronic component receiving stress. Then, if exceeding the allowable stress, there is a possibility of the electronic component no longer maintaining the functions thereof. In addition, in a case of arranging the electronic component in a portion adjacent to the inner liner, since the distance from the outer surface of the tire until the electronic component will be far, there is concern over the communication quality declining when the electronic component performs communication with the outside, etc.

The present invention has been made taking account of the above-mentioned problem, and an object thereof is to provide a tire in which an embedded electronic component can maintain the function thereof.

A tire (for example, the tire 1) according to a first aspect of the present invention includes: a carcass ply (for example, the carcass ply 23) which extends from one bead to an other bead core; side-wall rubber (for example, the side-wall rubber 30) which is disposed at an outer side in a tire-width direction of the carcass ply; a belt (for example, the steel belt 26) which is disposed at an outer side in a tire-radial direction of the carcass ply of a tread; and a pad (for example, the shoulder pad 38) which is disposed between the carcass ply and an end region in the tire-width direction of the belt, in which the pad extends up to an outer side in the tire-width direction, the pad and the side-wall rubber are laminated at a part of the carcass ply, and an electronic component (for example, the RFID tag 40) is embedded between the pad and the side-wall rubber.

According to a second aspect of the present invention, in the tire as described in the first aspect, the electronic component may be disposed at a portion on an outer side in the tire-radial direction on a boundary between the pad and the side-wall rubber.

According to a third aspect of the present invention, in the tire as described in the first or second aspect, the electronic component may be disposed so that a distance (for example, the distance S) in the tire-width direction between the electronic component and the carcass ply becomes at least a thickness (for example, the thickness t) of the carcass ply.

According to a fourth aspect of the present invention, in the tire as described in any of the first to third aspects, the electronic component may be covered by a first rubber sheet (for example, the first rubber sheet 431) serving as a protective layer disposed at an inner side in the tire-width direction of the electronic component, and a second rubber sheet (for example, the second rubber sheet 432) disposed at an outer side in the tire-width direction of the electronic component, and the first rubber sheet and the second rubber sheet may be configured from rubber having a higher modulus than the side-wall rubber, and a lower modulus than the pad.

According to the present invention, it is possible to provide a tire in which an embedded electronic component can maintain the function thereof.

### BRIEF DESCRIPTION OF THE DRAWINGS

FIG. 1 is a view showing a half section in a tire-width direction of a tire according to a first embodiment of the present invention;

FIG. 2 is a partially enlarged cross-sectional view of a tire according to the first embodiment of the present invention;

FIG. 3 is a partially enlarged cross-sectional view of a tire according to a first embodiment of the present invention;

FIG. 4A is a view showing an RFID tag which is protected by a protective member in a tire according to a second embodiment of the present invention;

FIG. 4B is a view showing a cross section along the line b-b in FIG. 4A;

FIG. 4C is a view showing a cross section along the line c-c in FIG. 4A;

FIG. 5 is a view showing a cross section prior to interposing the RFID tag by rubber sheets in a case of not filling rubber inside a spring antenna;

FIG. 6 is a view showing a cross section after interposing an RFID tag by rubber sheets, in a case of not filling rubber into the spring antenna;

FIG. 7 is a view showing a cross section after interposing the RFID tag by rubber sheets in a case of not filling rubber inside a spring antenna;

FIG. 8 is a view showing the RFID tag prior to filling rubber inside a spring antenna in a tire according to a third embodiment of the present invention;

FIG. 9 is a view showing the RFID tag after filling rubber inside a spring antenna in a tire according to the third embodiment of the present invention;

FIG. 10 is a view showing the RFID tag prior to interposing by rubber sheets, in a tire according to the third embodiment of the present invention; and

FIG. 11 is a view showing the RFID tag interposed by rubber sheets, in a tire according to the third embodiment of the present invention.

### DETAILED DESCRIPTION

### First Embodiment

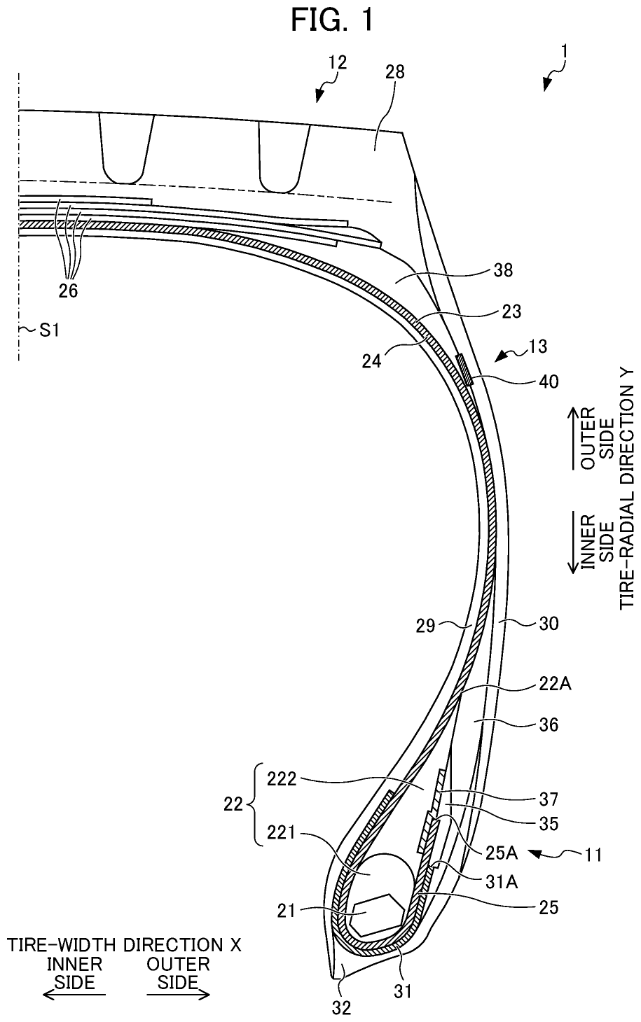

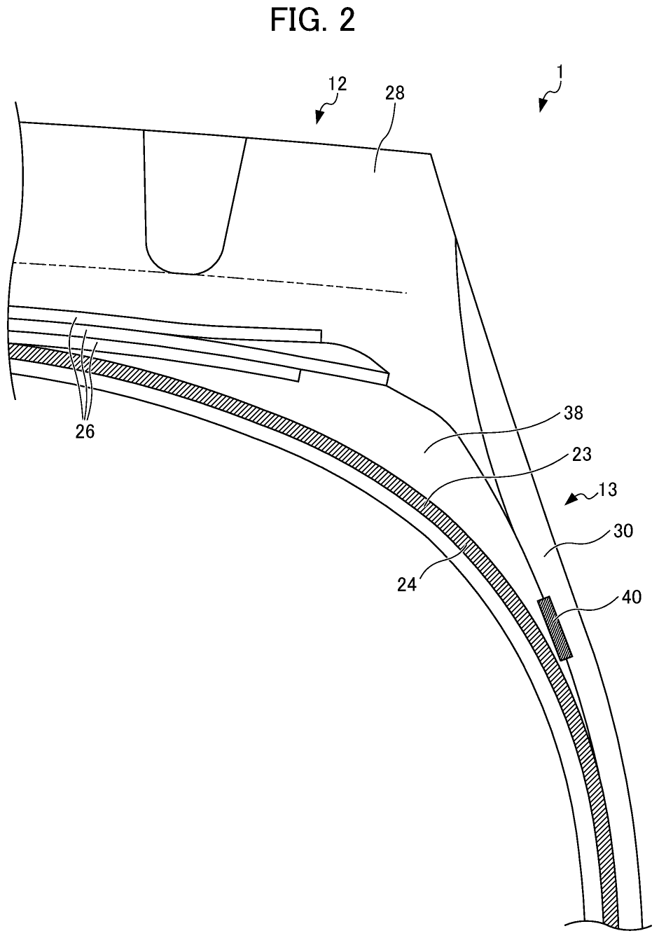

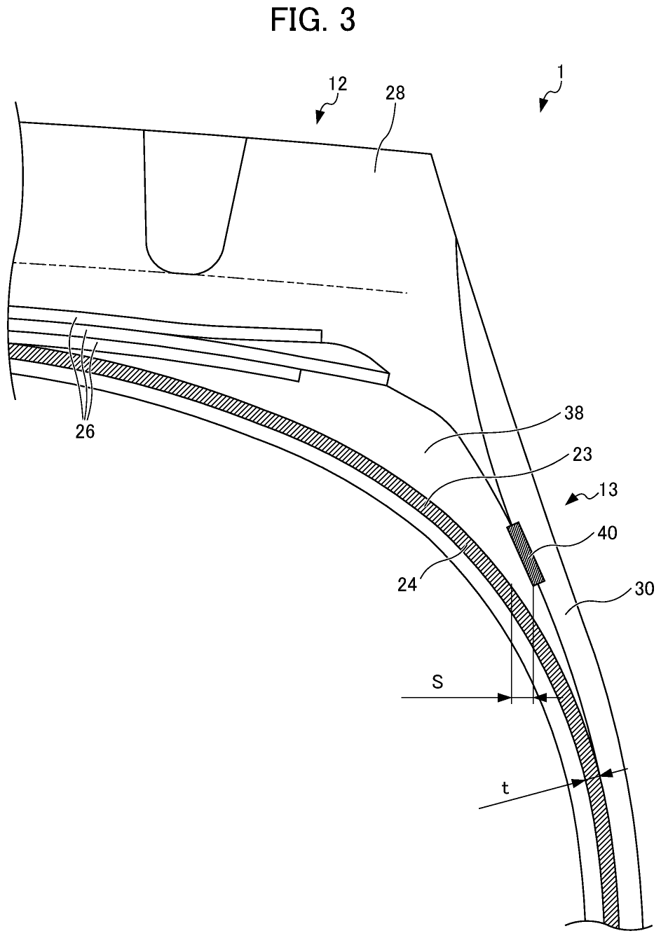

Hereinafter, a first embodiment of the present invention will be explained while referencing the drawings. FIG. 1 is a view showing a half section in a tire-width direction of a tire 1 according to the present embodiment. The basic structure of the tire is left/right symmetric in the cross section of the tire-width direction; therefore, a cross-sectional view of the right half is shown herein. In the drawings, the reference symbol S1 is the tire equatorial plane. The tire equatorial plane S1 is a plane orthogonal to the tire rotation axis, and is positioned in the center of the tire-width direction. Herein, tire-width direction is a direction parallel to the tire rotation axis, and is the left/right direction of the paper plane of the cross-sectional view in FIG. 1. In FIG. 1, it is illustrated as the tire-width direction X. Then, inner-side of tire-width direction is a direction approaching the tire equatorial plane S1, and is the left side of the paper plane in FIG. 1. Outer side of tire-width direction is a direction distancing from the tire equatorial plane S1, and is the right side of the paper plane in FIG. 1. In addition, tire-radial direction is a direction perpendicular to the tire rotation axis, and is the vertical direction in the paper plane of FIG. 1. In FIG. 1, it is illustrated as the tire-radial direction Y. Then, outer-side of tire-radial direction is a direction distancing from the tire rotation axis, and is the upper side of the paper plane in FIG. 1. Inner-side of tire-radial direction is a direction approaching the tire rotation axis, and is the lower side of the paper plane in FIG. 1. The same also applies to FIGS. 2 and 3.

The tire 1 is a tire for trucks and buses, for example, and includes a pair of beads 11 provided at both sides in the tire width direction, tread 12 forming a contact patch with the road surface, and a pair of sidewalls 13 which extends between the pair of beads and the tread 12.

The bead 11 includes an annular bead core 21 formed by wrapping around several times bead wires made of metal coated with rubber, and a bead filler 22 of tapered shape extending to the outer side in the tire-radial direction of the bead core 21. The bead filler 22 is configured by a first bead filler 221 which covers the outer circumference of the bead core 21, and a second bead filler 222 which is arranged on the outer side in the tire-radial direction of the first bead filler 221. The second bead filler 222 is configured from rubber with a modulus higher than an inner liner 29 and side wall rubber 30 described later. Then, the first bead filler 221 is configured from rubber of an even higher modulus than the second bead filler 222. It should be noted that the first bead filler 221 may be a form not covering the outer circumference of the bead core 21, if at least a part thereof is arranged on the outer side in the tire-radial direction of the bead core 21. In addition, the bead filler 22 may be formed from rubber of one type. In other words, it may not necessarily be divided into the first bead filler 221 and second bead filler 222. The bead core 21 is a member which plays a role of fixing a tire filled with air to the rim of a wheel which is not illustrated. The bead filler 22 is a member provided in order to raise the rigidity of the bead peripheral part and to ensure high maneuverability and stability.

A carcass ply 23 constituting a ply serving as the skeleton of the tire is embedded inside of the tire 1. The carcass ply 23 extends from one bead core to the other bead core. In other words, it is embedded in the tire 1 between the pair of bead cores 21, in a form passing through the pair of side walls 13 and the tread 12. As shown in FIG. 1, the carcass ply 23 includes a ply body 24 which extends from one bead core to the other bead core, and extends between the tread 12 and bead 11, and a ply folding part 25 which is folded around the bead core 21. Herein, a folding end 25A of the ply folding part 25 is positioned more to an inner side in the tire-radial direction than a tire-radial direction outside end 22A of the bead filler 22. The carcass ply 23 is configured by a plurality of ply cords extending in a tire-width direction. In addition, a plurality of ply cords is arranged side by side in a tire circumferential direction. This ply cord is configured by a metal steel cord, or an insulated organic fiber cord such as polyester or polyamide, or the like, and is covered by rubber.

In the tread 12, a plurality of layers of steel belts 26 serving as belts is provided in the outer side in the tire radial direction of the carcass ply 23. The steel belt 26 is configured by a plurality of steel cords covered by rubber. By providing the steel belts 26, the rigidity of the tire is ensured, and the contact state of the road surface with the tread 12 improves. In the present embodiment, although four layers of steel belts 26 are provided, the number of layered steel belt 26 is not limited thereto.

The tread rubber 28 is provided at the outer side in the tire-radial direction of the steel belt 26. A tread pattern (not illustrated) is provided to the outer surface of the tread rubber 28, and this outer surface serves as a contact surface which contacts with the road surface.

In the tire-width direction outside vicinity of the tread 12, i.e. in an end region in the tire-width direction of the steel belt 26 and tread rubber 28, a shoulder pad 38 serving as the pad is provided in a region between the carcass ply 23, and the steel belt 26 and tread rubber 28. This shoulder pad 38 extends until a region of the outer side in the tire-radial direction of the side wall 13, and part thereof forms an interface between side wall rubber 30 described later. In other words, in the region of the outer side in the tire radial direction of the side wall 13, a part of the shoulder pad 38 is present on the inner side in the tire width direction of the side wall rubber 30. In other words, the extending part of the shoulder pad 38 and the side-wall rubber 30 are laminated in order on the carcass ply 23, from the inner cavity side of the tire towards the outer surface side of the tire, at an extending part of the shoulder pad 38. In other words, at one part of the carcass ply 23, the shoulder pad 38 and side-wall rubber 30 are laminated. The shoulder pad 38 consists of a rubber member having cushioning, and exhibits a cushion function between the carcass ply 23 and steel belt 26. In addition, since the shoulder pad 38 consists of rubber having a characteristic of low heat buildup, it is possible to suppress heat generation effectively, by extending until the side wall 13.

In the bead 11, side wall 13 and tread 12, an inner liner 29 serving as a rubber layer constituting an inside wall surface of the tire 1 is provided to a tire inner cavity side of the carcass ply 23. The inner liner 29 is configured by air permeation resistant rubber, whereby the air inside the tire inner cavity is prevented from leaking to outside.

In the side wall 13, the side wall rubber 30 constituting the outer wall surface of the tire 1 is provided to the outer side in the tire-width direction of the carcass ply 23. This side wall rubber 30 is a portion which bends the most upon the tire exhibiting a cushioning action, and usually flexible rubber having fatigue resistance is adopted therein.

On the inner side in the tire radial direction of the carcass ply 23 provided around the bead core 21 of the bead 11, a steel chafer 31 serving as a reinforcement ply is provided so as to cover at least part of the carcass ply 23. The steel chafer 31 also extends to the outer side in the tire-width direction of the ply folding part 25 of the carcass ply 23, and an end part 31A of this steel chafer 31 is positioned more to the inner side in the tire-width direction than the folding end 25A of the ply folding part 25. This steel chafer 31 is a metal reinforcement layer configured by metal steel cords, and is covered by rubber.

Rim strip rubber 32 is provided at the inner side in the tire-radial direction of the steel chafer 31. This rim strip rubber 32 is arranged along the outer surface of the tire, and connects with the side wall rubber 30. This rim strip rubber 32 and side wall rubber 30 are rubber members constituting the outer surface of the tire.

Then, at the outer side in the tire-radial direction of the end part 31A of the steel chafer 31, which is at the outer side in the tire-width direction of the folding part 25 of the carcass ply 23 and bead filler 22, a first pad 35 is provided. This first pad 35 is provided so as to cover the outer side in the tire-width direction of at least the folding end 25A of the ply folding part 25. The outer side in the tire-radial direction of the first pad 35 is formed so as to taper as approaching the outer side in the tire-radial direction.

Furthermore, a second pad 36 is provided so as to cover the outer side in the tire-width direction of the first pad 35. In more detail, the second pad 36 is provided so as to cover the outer side in the tire-width direction of part of the steel chafer 31, the first pad 35, part of the second bead filler 222, and part of the ply body 24 of the carcass ply 23. Then, the side-wall rubber 30 is arranged at an outer side in the tire-width direction of the tire-radial direction outside region of the second pad 36, and rim strip rubber 32 is arranged at an outer side in the tire-width direction of the tire-radial direction inside region of the second pad 36. In other words, the second pad 36 is provided between the first pad 35, etc., and the rim strip rubber 32 and side wall rubber 30, which are members constituting the outer surface of the tire.

Herein, the first pad 35 and second pad 36 are configured by rubber of higher modulus than the modulus of the bead filler (second bead filler 222) to which these members contact. In more detail, the second pad 36 is configured by rubber of higher modulus than the second bead filler 222, and the first pad 35 is configured by rubber of even higher modulus than the second pad 36. The first pad 35 and second pad 36 have a function of mitigating sudden distortion caused by the local rigidity point of change at the folding end 25A of the carcass ply 23 and the end part 31A of the steel chafer 31.

At the inner side in the tire-width direction of the first pad 35, a rubber sheet 37 is arranged in the vicinity of the folding end 25A of the ply folding part 25. The rubber sheet 37 is arranged so as to cover at least the folding end 25A of the ply folding part 25 from the inner side in the tire-width direction.

Generally, at the folding end 25A of the ply folding part 25, stress tends to concentrate. However, by providing the aforementioned first pad 35 and second pad 36, and further arranging the rubber sheet 37, it becomes possible to effective suppress the concentration of stress.

An RFID tag 40 is embedded as an electrical component in the tire 1 of the present embodiment. The RFID tag 40 is a passive transponder equipped with an RFID chip and an antenna for performing communication with external equipment, and performs wireless communication with a reader (not illustrated) serving as the external equipment. As the antenna, a coil-shaped spring antenna, plate-shaped antenna, and various types of rod-shaped antennas can be used. For example, it may be an antenna formed by printing a predetermined pattern on a flexible substrate. The antenna is established at an antenna length optimized according to the frequency band, etc. to be used. In a storage part inside the RFID chip, identification information such as a manufacturing number and part number is stored.

FIG. 2 is an enlarged cross-sectional view showing an embedded part periphery of the RFID tag 40 in the tire 1 of FIG. 1. As shown in FIGS. 1 and 2, the RFID tag 40 is embedded between the shoulder pad 38 and side-wall rubber 30. This position is a region in which the influence due to compression and shear strain is small, and thus is suitable as the arrangement position of the RFID tag 40.

In addition, by arranging the RFID tag 40 at the shoulder part, i.e. the tire-radial direction outside vicinity of the side wall, it is possible to arrange the RFID tag 40 at a position sufficiently distanced from the bead core 21 made of metal, which has a possibility of adversely influencing communication. Herein, the bead core 21 is formed in a ring shape by laminating and winding a bead wire made of metal; therefore, it is a metal member having a particularly high possibility of adversely influencing communication. In addition, when considering communication quality, it is preferable for the RFID tag 40 to be arranged in a portion of the tire 1 as close as possible to the outer surface. Assuming that the RFID tag 40 were arranged at the inner cavity side of the carcass ply 23, the communication quality would drop due to being distanced from the outer surface of the tire 1. Furthermore, in the case of the carcass ply 23 being metal, if arranging the RFID tag 40 at the inner cavity side of the carcass ply 23, the communication quality will decline remarkably. When considering these points, between the shoulder pad 38 and side-wall rubber 30 is suitable as an embedding position of the RFID tag 40.

In addition, if considering the matter of embedding the RFID tag 40 during the manufacturing process of the tire, it is preferable to interpose the RFID tag 40 between different rubber members constituting the tire. For example, in the case of interposing the RFID tag 40 between layers of ribbon-like rubber members which are wound, the timing, etc. at which pasting the RIFD tag to the ribbon-like rubber member becomes complicated. On the other hand, so long as arranging between different rubber members as in the present embodiment, upon pasting the RFID tag 40 precisely to one rubber member in the molding process of the tire, it is possible to interpose the RFID tag 40 by superimposing the other rubber member with this. Even when considering these points, between the shoulder pad 38 and side-wall rubber 30 is preferable as the embedding position of the RFID tag 40.

In addition, even in the case of arranging the RFID tag 40 to be interposed between plies such as the carcass ply 23, when the interposing plies move in different directions from each other, for example, there is a possible of stress acting on the RFID tag 40. In addition, even in a case of the RFID tag 40 being interposed between a ply such as the carcass ply 23 and a rubber member such as the side-wall rubber, since the properties greatly differ between the ply and rubber member, relative movement arises between both members during vulcanization and during use due to differences in properties thereof, for example, differences in linear expansion coefficient, elastic modulus, hardness, etc., and thus there is a possibility of the RFID tag 40 receiving stress. Then, if exceeding the allowable stress, there is a possibility of the RFID tag 40 no longer maintaining the function thereof. The shoulder pad 38 and side-wall rubber 30 are both rubber members, and even when considering these points, between the shoulder pad 38 and side-wall rubber 30 is suitable as the embedding position of the RFID tag 40.

It should be noted that the shoulder pad 38 has a cushioning property. Consequently, so long as arranging the RFID tag 40 at this portion, it is possible to absorb the strain produced at the periphery of the RFID tag 40. In addition, the shoulder pad is low heat generation. Consequently, the RFID tag 40 provided at such a position is hardly influenced by the heat generation of rubber during use. Even when considering these points, between the shoulder pad 38 and side-wall rubber 30 is suitable as the embedding position of the RFID tag 40.

Furthermore, so long as the RFID tag 40 is arranged between the shoulder pad 38 and side-wall rubber 30, even in the case of performing retread, the RFID tag 40 will not be removed. In other words, since the portion removed in retread is the tread rubber 28, if arranging the RFID tag 40 between the shoulder pad 38 and side-wall rubber 30, the RFID tag 40 will not be removed, and can be used continuously. In this point as well, between the shoulder pad 38 and side-wall rubber 30 is suitable as the embedding position of the RFID tag 40.

It should be noted that, when establishing the modulus of the shoulder pad 38 as the standard, the side-wall rubber 30 is preferable set as 0.4 to 0.7 times the modulus of the shoulder pad 38. In addition, the tread rubber 28 is preferably set as 0.4 to 0.9 times the modulus of the shoulder pad 38. By establishing such a modulus, it is possible to keep a balance of flexibility and rigidity as a tire. It should be noted that the modulus indicates 100% elongation modulus (M100) under a 23° C. atmosphere, measured in accordance with “3.7 stress at a given elongation, S” of JIS K6251:2010.

It should be noted that, as shown in the cross-sectional enlarged view of FIG. 3, the RFID tag 40 is more preferably arranged at a portion on the outer side in the tire-radial direction, on the boundary between the shoulder pad 38 and side-wall rubber 30. Even if a case of the carcass ply 23 being made of metal, since the distance between the RFID tag 40 and carcass ply 23 thereby becomes far, the communication quality will improve. In addition, when focusing on the width direction of the tire, as shown in FIG. 3, it is preferable for the RFID tag 40 to be arranged so that the distance S in the tire-width direction between the carcass ply 23 and RFID tag 40 becomes at least the thickness t of the carcass ply 23. Even in a case of the carcass ply 23 being made of metal, since the distance between the RFID tag 40 and the carcass ply 23 thereby becomes far, the communication quality will improve.

Herein, the RFID tag 40 is mounted before the vulcanization process in the manufacturing process of tires. In the present embodiment, the RFID tag 40 is mounted to the shoulder pad 38 or side-wall rubber 30 prior to the rubber being vulcanized. At this time, the shoulder pad 38 and side-wall rubber 30 are in the state of raw rubber prior to vulcanization; therefore, the RFID tag 40 may be pasted to the shoulder pad 38 or side-wall rubber 30 using the adhesive property thereof. Alternatively, in a case of the adhesive property being low or the like, it may be pasted using an adhesive or the like. After pasting the RFID tag 40, the RFID 40 is interposed by the shoulder pad 38 and side-wall rubber 30. Subsequently, the green tire in which the respective constitutional parts including the RFID 40 are assembled is vulcanized in the vulcanization process to manufacture a tire.

In this way, in the present embodiment, during tire manufacture, since it is possible to paste the RFID tag 40 to the should pad 38 or side-wall rubber 30 which are in the raw rubber state, the assembly work of the RFID tag 40 in the manufacturing process of the tire is easy. In particular, since the shoulder pad 38 has a certain level of rigidity even in the raw rubber state, the mounting work of the RFID tag 40 is easy.

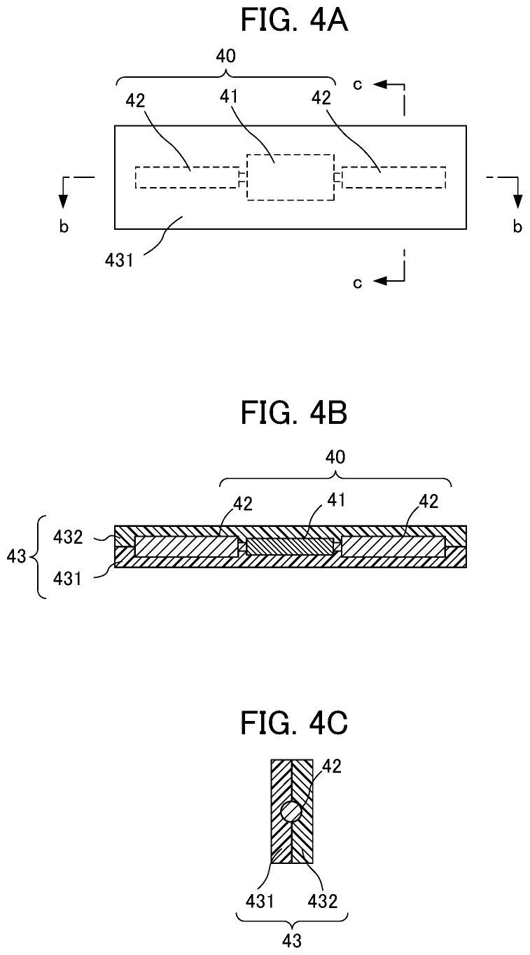

It should be noted that, if the RFID tag 40 embedded in the tire includes an antenna as illustrated as the RFID tag 40 in FIG. 4 described later, it often will have a longitudinal direction. Such an RFID tag 40 is preferably embedded in the tire 1, so that the longitudinal direction thereof becomes the direction of a tangential line relative to the circumferential direction of the tire, i.e. a direction orthogonal to the paper plane of cross-sectional view in FIGS. 1 and 2. By embedding in this way, stress hardly acts on the RFID tag 40 also when the tire deformed.

It should be noted that the RFID tag 40 may be sandwiched between the shoulder pad 38 and side-wall rubber 30, in a state covered by a protective member of rubber or the like; however, it may be sandwiched directly by the shoulder pad 38 and side-wall rubber 30 without covering by the protective member.

It should be noted that, in the present embodiment, the RFID tag 40 is embedded in the tire as the electronic component; however, the electronic component embedded in the tire is not limited to an RFID tag. For example, it may be various electronic components such as a sensor which carries out wireless communication. In addition, since the electronic component handles electrical information such as the transmission of electrical signals, there is a possibility of the performance declining due to metal components being present in the vicinity. In addition, there is a possibility of the electronic component being damaged by excessive stress acting thereon. Therefore, it is possible to obtain the effects of the present invention also in the case of embedding various electronic components in a tire. For example, the electronic component may be a piezoelectric element or strain sensor.

According to the tire 1 of the present embodiment, the following effects are exerted.

(1) The tire 1 according to the present embodiment has a shoulder pad 38 arranged between the carcass ply 23 and steel belt 26 which extends until the outer side of the tire-width direction, a side-wall rubber 30 is laminated with the shoulder pad 38 at a part of the carcass ply 23, and the RFID tag 40 is provided between the shoulder pad 38 and side-wall rubber 30. It is thereby possible to maintain the communication quality of the RFID tag 40. In addition, it is possible for the embedded RFID tag 40 to keep the function thereof, also upon the tire deforming during vulcanization or during use. Furthermore, the process of assembling the RFID tag 40 in the tire is also easy.

(2) The tire 1 according to the present embodiment is arranged at a portion on the outer side in the tire-radial direction on the boundary between the shoulder pad 38 and side-wall rubber 30. Even in a case of the carcass ply 23 being made of metal, it is thereby possible to maintain the communication quality.

(3) In the tire 1 according to the present embodiment, the RFID tag 40 is arranged so that the distance in the tire-width direction between the RFID tag 40 and carcass ply 23 becomes at least the thickness of the carcass ply 23. It is thereby possible to maintain the communication quality even in a case of the carcass ply 23 being made of metal.

### Second Embodiment

Next, a tire according to a second embodiment will be explained while referencing FIGS. 4A to 4C. It should be noted that, in the following explanation, the same reference symbol will be attached for configurations which are the same as the first embodiment, and detailed explanations thereof will be omitted.

FIG. 4A is a view showing the RFID tag 40 covered by a protective member 43 configured from a rubber sheet. In FIG. 4A, the RFID tag 40 is covered and hidden by the rubber sheet 431 described later. FIG. 4B is a cross-sectional view along the line b-b in FIG. 4A, and FIG. 4C is a cross-sectional view along the line c-c in FIG. 4A. In the present embodiment, as shown in FIGS. 4A to 4C, the RFID tag 40 is covered by the protective member 43.

The RFID tag 40 includes an RFID chip 41 and antenna 42 for performing communication with external equipment. As the antenna 42, a coil-shaped spring antenna, plate-shaped antenna, and various types of rod-shaped antennas can be used.

For example, it may be an antenna formed by printing a predetermined pattern on a flexible substrate. When considering the communicability and flexibility, a coil-shaped spring antenna is the most preferable. The antenna is established at an antenna length optimized according to the frequency band, etc. to be used.

The protective member 43 is configured from two rubber sheets 431, 432 which protect by sandwiching the RFID tag 40.

The protective member 43 is configured by rubber of a predetermined modulus, for example. Herein, the modulus indicates 100% elongation modulus (M100) under a 23° C. atmosphere, measured in accordance with “3.7 stress at a given elongation, S” of JIS K6251:2010.

As the rubber adopted in the protective member 43, rubber at least having a higher modulus than the side wall rubber 30 is used. For example, rubber having a higher modulus than the side wall rubber 30 and lower modulus than the shoulder pad 38 is used.

For example, with the modulus of the side wall rubber 30 as a reference, as the rubber used in the protective member 43, it is preferable to use rubber of a modulus 1.1 to 1.8 times. At this time, as the rubber of the shoulder pad 38, rubber of a modulus 1.6 to 3 times that of the side wall rubber, for example, rubber of a modulus on the order of 2 times thereof, may be used. It should be noted that, if emphasizing reinforcement of the protection of the RFID tag 40, rubber of a modulus higher than the shoulder pad 38 may be adopted as the rubber used in the protective member 43.

It should be noted that, as shown in FIGS. 1 and 2, the RFID tag 40 is arranged in the region between the shoulder pad 38 and side-wall rubber 30. Therefore, by setting the modulus of the protective member 43 to a value with a higher modulus than the side-wall rubber 30 and a lower modulus than the shoulder pad 38, in the case of the tire distorting, it is possible to prevent excess stress from generating within the rubber structure at the embedded part of the RFID tag 40. In other words, it is possible to suppress the generation of stress.

In addition, the protective member 43 may be configured from a short-fiber filler mixed rubber. As the short-fiber filler, for example, it is possible to use insulating short fibers like organic short fibers such as aramid short fibers and cellulose short fibers; inorganic short fibers such as ceramic short fibers as in alumina short fiber, and glass short fiber. By mixing such short-fiber fillers into rubber, it is possible to raise the strength of the rubber. In addition, as the protective member 43, a rubber sheet in the vulcanized state may be used. The rubber sheet in a vulcanized state does not plastically deform as raw rubber, and thus can appropriately protect the RFID tag 40.

In addition, as the protective member 43, an organic fiber layer from polyester fibers or polyamide fibers may be provided. It is also possible to embed an organic fiber layer in the two rubber sheets 431, 432.

In this way, if configuring the protective member 43 by two rubber sheets, since it is possible to thinly form the RFID tag 40 including the protective member 43, it is favorable upon embedding in the tire 1. In addition, when assembling the RFID tag 40 in the constitutional members of the tire 1 prior to vulcanization, the RFID tag 40 covered by the rubber sheets can be installed very easily. For example, at a desired position of a member such as the shoulder pad 38 and side-wall rubber 30 prior to vulcanization, it is possible to appropriately paste the RFID tag 40 covered by the rubber sheets using the adhesiveness of the raw rubber. In addition, by also establishing the rubber sheets as raw rubber prior to vulcanization, it is possible to more easily paste by employing the adhesiveness of the rubber sheet itself as well.

However, the protective member 43 is not limited to the form configured by two rubber sheets, and can adopt various forms. For example, at least one rubber sheet constituting the protective member, so long as covering at least part of the RFID tag 40, can obtain effects such as an improvement in workability in the manufacturing process and stress mitigation. In addition, for example, it may be a configuration wrapping one rubber sheet around the entire circumference of the RFID tag 40, or a configuration attaching the protective member in the form of a potting agent of high viscosity along the entire circumference of the RFID tag 40. Even if such a configuration, it will be possible to appropriately protect the RFID tag 40.

It should be noted that the RFID tag 40 covered by the protective member 43 is embedded in the tire so that the longitudinal direction thereof becomes the direction of the tangential line relative to the circumferential direction of the tire, i.e. direction orthogonal to the paper plane in the cross-sectional view of FIGS. 1 to 3. In addition, the rubber sheets 431, 432 are embedded in the tire in a form such that aligns in the tire-width direction. In other words, in the manufacturing process, one surface of either one of the rubber sheets 431, 432 is pasted to a constituent member of the tire prior to vulcanization, e.g., the shoulder pad 38. By establishing such a form, stress will hardly act on the RFID tag 40, even when the tire deforms. In addition, in the manufacturing process, the work of attaching the RFID tag 40 covered by the protective member 43 becomes easy.

According to the tire of the present embodiment, the following effects are exerted in addition to the above (1) to (3).

(4) In the present embodiment, the protective member 43 is configured from rubber of a modulus higher than the side-wall rubber 30, and lower than the shoulder pad 38, and the RFID tag 40 covered by this protective member 43 is embedded in the tire. Consequently, since the modulus of rubber in the tire changes stepwise, in the case of the tire deforming, it is possible to prevent excessive stress occurring within the rubber structure in the RFID tag 40 embedded part.

### Third Embodiment

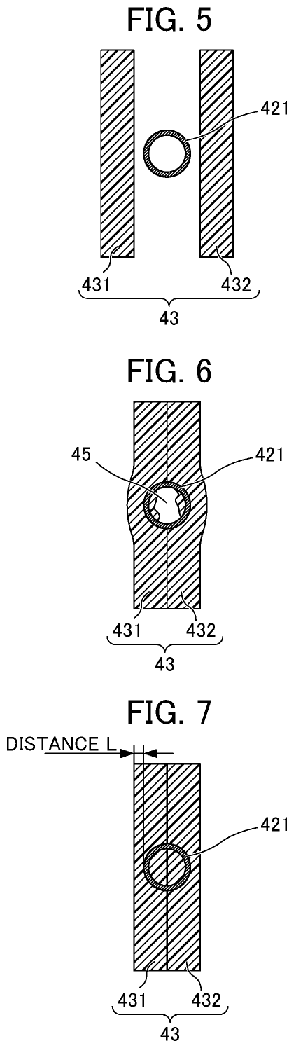

Next, a tire according to a third embodiment will be explained while referencing FIGS. 5 to 11. It should be noted that, in the following explanation, the same reference symbol will be attached for configurations which are the same as the second embodiment, and detailed explanations thereof will be omitted. The present embodiment is a particularly preferable embodiment in the case of the antenna of the RFID tag 40 being a coil-shaped spring antenna.

In the RFID tag 40 of the present embodiment, a coil-shaped spring antenna 421 having high communicability and flexibility can be used as the antenna. The spring antenna 421 is set to an antenna length which was optimized according to the frequency band, etc. to be used.

In the present embodiment, prior to interposing the RFID tag 40 by the two rubber sheets 431, 432 constituting the protective member 43, the rubber is arranged within the spring antenna 421. More preferably, rubber is filled into the spring antenna, so that air will not remain as much as possible. This process and the reason for adopting this process will be explained using FIGS. 5 to 11.

First, a state of the surroundings of the RFID tag 40 in a case of not filling rubber into the spring antenna 421 will be explained as a reference example using FIGS. 5 to 7. FIG. 5 is a view showing a cross section of the spring antenna 421, and rubber sheets 431, 432, prior to interposing the RFID tag 40 by the rubber sheets 431, 432. FIG. 6 is a view showing a cross section of the spring antenna 421, and rubber sheets 431, 432, after interposing the RFID tag 40 by the rubber sheets 431, 432.

As shown in FIG. 6, in this reference example, since rubber is not filled into the spring antenna 421 in advance, a certain amount of air 45 may remain within the spring antenna 421 after interposing by the rubber sheets 431, 432. If air remains in this way, the integrity of the rubber sheets 431, 432 and the spring antenna 421 becomes insufficient, and when the tire deforms, there is concern over the spring antenna 421 not following the motion of the rubber, and the RFID tag 40 having the spring antenna 421 being damaged.

It should be noted that raw rubber before vulcanization is used as the rubber sheets 431, 432 herein. Consequently, by pushing the rubber sheets 431, 432 from both sides, the rubber sheets 431, 432 sticks to some extent inside the spring antenna as shown in FIG. 6. However, very large amounts of time and labor are required in order to stick the rubber sheets 431, 432 until the inside of the spring antenna is completely embedded.

Then, even if assuming a case of taking time and sticking the rubber sheets until the inside of the spring antenna is embedded, the distance L between the outer circumferential part of the spring antenna 421 and the outer surface of the rubber sheets 431, 432 becomes very short, as shown in FIG. 7. In addition, it is difficult to stabilize this distance L, and locally thin portions can occur. Consequently, the protection of the RFID tag 40 by the rubber sheets 431, 42 becomes insufficient, and during vulcanization, there is a possibility of the rubber sheets 431, 432 being damaged.

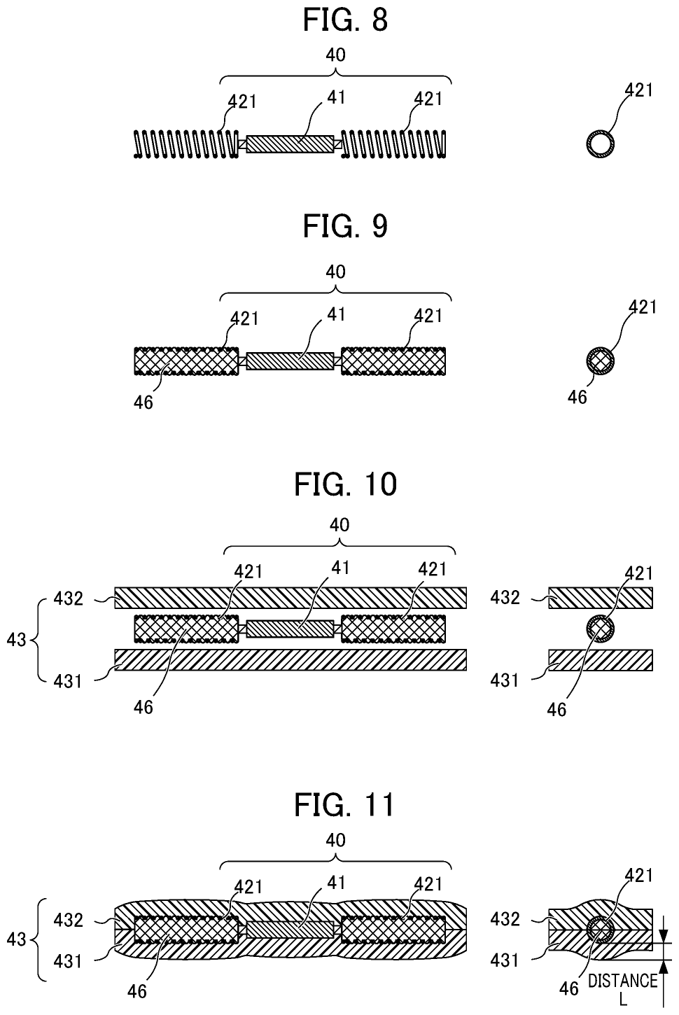

Therefore, in the present embodiment, prior to interposing the RFID tag 40 by the rubber sheets 431, 432, the rubber is arranged within the spring antenna 421, as shown in FIGS. 8 to 11. More preferably, rubber is filled within the spring antenna so that air does not remain as much as possible. It should be noted that the views shown on the right sides of FIGS. 8 to 11 are views showing a transverse section of the spring antenna 421 and the surrounding thereof.

FIG. 8 is a view showing a state prior to filling the rubber 46 into the spring antenna 421, and FIG. 9 is a view showing a state after filling the rubber 46 into the spring antenna 421. The rubber 46 is embedded so as to be almost the same outside diameter as the outer circumferential face of the spring antenna 421. Then, in the case of the rubber 46 escaping from the outer circumferential face of the spring antenna 421, it is preferable to wipe off this portion. In other words, the outer circumferential face of the rubber 46 is preferably molded so as to become substantially the same surface as the outer circumferential face of the spring antenna 421. It should be noted that the rubber 46 may be filled into the spring antenna 421, and the outer circumference of the spring antenna 421 may be thinly wrapped by the rubber 46. On the other hand, if thickly wrapping the spring antenna 421 by the rubber 46, in addition to the flexibility of the spring antenna 421 being harmed, the dimension in the width direction formed by the rubber sheets 431, 432 after interposing the RFID tag 40 becomes larger, which is not preferable. It should be noted that the rubber 46 may be embedded so as to become substantially the same outside diameter as the inner circumferential face of the spring antenna 421. It is desirable for the outer circumferential part of the rubber 46 to be located within the range of the inner circumferential face and outer circumferential face of the spring antenna 421.

Herein, rubber having flexibility is used as the rubber 46 in order to ensure the flexibility of the spring antenna 421. However, it is preferable to use rubber of a modulus higher than the rubber sheets 431, 432 as the rubber 46, in consideration of the workability, etc. It should be noted that preferably unvulcanized rubber is used as the rubber 46 arranged within the spring antenna 421. By establishing the rubber 46 and rubber sheets 431, 432 as unvulcanized rubber and vulcanizing simultaneously, the integrity of the rubber 46, rubber sheets 431, 432 and spring antenna 421 rises. In addition, the rubber 46, and rubber sheets 431, 432 are more preferably established as the same type of rubber. It should be noted that, by emphasizing the flexibility of the spring antenna 421, rubber of lower modulus than the rubber sheets 431, 432 may be used as the rubber 46. In addition, rubber of substantially the same modulus, and rubber of the same material may be used. It should be noted that vulcanized rubber may be used as the rubber 46 arranged within the spring antenna 421. In addition, rubber-based adhesive, rubber-based filler, etc. can also be used. Taking account of configuring so as not to leave air within the spring antenna 421 as much as possible, while ensuring flexibility, it is possible to adopt various rubber-based materials. As the arranging operation of the rubber 46, various methods can be adopted; however, for example, it is also possible to inject rubber into the spring antenna 421 using a syringe. In this case, a set appropriate amount of the rubber 46 may be filled using a syringe. In addition, after filling a large amount of the rubber 46, portions protruding from the outer circumference of the spring antenna 421 may be wiped off.

FIG. 10 is a view showing a state prior to interposing the RFID tag 40 into which the rubber 46 is filled in the spring antenna 421, by the rubber sheets 431, 432, and FIG. 11 is a view showing a state after interposing by the rubber sheets 431, 432.

As shown in FIG. 11, according to the present embodiment, since the rubber 46 is filled in advance into the spring antenna 421, no air pockets exist between the rubber sheets 431, 432. Consequently, since it is unnecessary to be concerned over air pockets, the process of interposing the RFID tag 40 by the rubber sheets 431, 432 also becomes easy. In addition, by the rubber 46 being arranged within the spring antenna 421, the integrity of the spring antenna 421, rubber 46, and rubber sheets 431, 432 rises, and when the tire deforms, the spring antenna 421 follows the movement of the rubber. Consequently, the durability of the RFID tag 40 having the spring antenna 421 also improves.

In addition, according to the present embodiment, the distance L between the outer circumferential part of the spring antenna 421 and the outer circumferential face of the rubber sheets 431, 432 stabilizes. In other words, a distance close to the thickness of the rubber sheets 431, 432 is generally secured as this distance L. Consequently, the RFID tag 40 is sufficiently protected by the rubber sheets 431, 432. In the present embodiment, the RFID tag 40 interposed by the rubber sheets 431, 432 is fixedly set up at the shoulder pad 38, etc., and subsequently, the green tire is vulcanized.

According to the tire of the present embodiment, the following effects are exerted in addition to the above (1) to (4).

(5) The present embodiment provides a step of arranging the rubber 46 within the spring antenna 421 of the RFID tag 40 serving as an electronic component having a communication function; a step of interposing the RFID tag 40 having the spring antenna 421 into which the rubber 46 was arranged, by the rubber sheets 431, 432, and an arrangement step of arranging the RFID tag 40 interposed by the rubber sheets 431, 432 in the tire 1. The air 45 will thereby not remain inside the spring antenna 421. In addition, since it is unnecessary to be concerned about air pockets, the work of interposing the RFID tag 40 by the rubber sheets 431, 432 also becomes easy. In addition, since the distance L between the outer circumferential part of the spring antenna 421 and the outer surface of the rubber sheets 431, 432 is stabilized, the RFID tag 40 is sufficiently protected by the rubber sheets 431, 432. In the case of an embodiment in which the RFID tag 40 is embedded between the shoulder pad 38 and side-wall rubber 30 as in the tire of the present embodiment, i.e. case of being embedded in a portion of the tire near the outer surface, such air pocket countermeasures and enhanced protection measures are particularly effective.

It should be noted that, although the tire of the present invention can be adopted as various types of tires such as for cars, light trucks, trucks and buses, it is particularly suitable as a tire of a truck, bus, etc. It should be noted that the present invention is not to be limited to the above-mentioned embodiments, and that even when carrying out modifications, improvements, etc. within a scope capable of achieving the object of the present invention, it is encompassed by the scope of the present invention.

What is claimed is:

1. A tire comprising:
a carcass ply which extends from one bead to an other bead core;
side-wall rubber which is disposed at an outer side in a tire-width direction of the carcass ply;
a belt which is disposed at an outer side in a tire-radial direction of the carcass ply of a tread; and
a pad which is disposed between the carcass ply and an end region in the tire-width direction of the belt,
wherein the pad extends up to an outer side in the tire-width direction,
wherein the pad and the side-wall rubber are laminated at a part of the carcass ply, and
wherein an electronic component is embedded between the pad and the side-wall rubber.

2. The tire according to claim 1, wherein the electronic component is disposed at a portion on an outer side in the tire-radial direction on a boundary between the pad and the side-wall rubber.

3. The tire according to claim 1, wherein the electronic component is disposed so that a distance in the tire-width direction between the electronic component and the carcass ply becomes at least a thickness of the carcass ply.

4. The tire according to claim 1,
wherein the electronic component is covered by a first rubber sheet serving as a protective layer disposed at an inner side in the tire-width direction of the electronic component, and a second rubber sheet disposed at an outer side in the tire-width direction of the electronic component, and
wherein the first rubber sheet and the second rubber sheet are configured from rubber having a higher modulus than the side-wall rubber, and a lower modulus than the pad.
